(19) United States
(12) Patent Application Publication
(10) Pub. No.: US 2007/0094885 A1
(43) Pub. Date: May 3, 2007

(54) Apparatus and method for removing trace amounts of liquid from substrates during single-substrate processing

(76) Inventor: Alan Walter, Chester Springs, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/266,402

(22) Filed: Nov. 3, 2005

(51) Int. Cl. F26B 25/18; F26B 11/02

(52) U.S. Cl. 34/237; 34/109

(57) ABSTRACT

An apparatus and method for drying substrates in single-wafer processing chambers by providing capillary material at those areas where the substrate contacts a rotatable support. The capillary material will draw in, by capillary force, any liquid that is trapped between the substrate and the support at the areas of contact, thus reducing the edge exclusion area of the substrate and increasing yield. The inventive apparatus, in one aspect, comprises: a rotatable support comprising a fixture for supporting a substrate in a substantially horizontal orientation by contacting only a perimeter region of a substrate; the fixture comprising one or more contact surfaces that contact and support the perimeter region of the substrate; and wherein the one or more contact surfaces comprise a capillary material.

### TECHNICAL FIELD OF THE INVENTION

The present invention relates to apparatus and processes for drying objects, especially silicon wafer substrates, flat panel display substrates, and other types of substrates which must be cleaned, rinsed, and dried during the manufacture of a device. The invention especially relates to removing remaining amounts of liquid from silicon wafer substrates during the manufacture of integrated circuits. However, the invention can also be applied to the manufacture of raw wafers, lead frames, medical devices, disks and heads, flat panel displays, microelectronic masks, and other applications requiring high level cleanliness and/or drying during processing.

### BACKGROUND OF THE INVENTION

In the manufacture of semiconductors, semiconductor devices are produced on thin disk-like substrates. Generally, each substrate contains a plurality of semiconductor devices. The exact number of semiconductor devices that can be produced on any single substrate depends both on the size of the substrate and the size of the semiconductor devices being produced thereon. However, semiconductor devices have been becoming more and more miniaturized. As a result of this miniaturization, an increased number of semiconductor devices can be produced for any given area, thus, making the surface area of each substrate more and more valuable.

In producing semiconductor devices, substrates are subjected to a multitude of processing steps before a viable end product can be produced. These processing steps include: chemical-etching, wafer grinding, photoresist stripping, and masking. These steps typically occur in a process tank and often require that each substrate undergo many cycles of cleaning, rinsing, and drying during processing so that particles that may contaminate and cause devices to fail are removed from the substrates. However, these rinsing and drying steps can introduce additional problems in of themselves.

One major problem is the failure of the drying step to completely remove liquid from the substrates after rinsing (or any other processing step where the substrate is exposed to a liquid). It is well known in the art that those semiconductor devices that are produced from an area of the substrate where liquid droplets remained have a greater likelihood of failing. Thus, in order to increase the yield of properly functioning devices per substrate, it is imperative that all liquid be removed from the substrate surface as completely as possible.

Very sophisticated systems and methods have been devised to dry substrates as quickly and as completely as possible. However, due to deficiencies of prior art systems and methods of drying it is impossible to completely remove all traces of liquid from the substrate surfaces in an efficient and inexpensive manner. When substrates are placed in a tank for processing, the substrates are typically supported in an upright position by a support device which can be a carrier or an object support member that is built into the process tank itself. It is a well recognized problem in the art to quickly and effectively remove traces of water from those areas of the substrate that are in contact with the supporting device. Therefore, there is a certain very valuable portion of the substrate which is wasted due to what is known in the art as “edge exclusion,” a term referring to the portion of the substrate near the edges which cannot be completely dried and must be discarded. Because semiconductor devices are becoming more miniaturized, the “edge exclusion” areas are also becoming more valuable in that an increased number of functioning devices would be able to be produced from these areas if it were not for the water-spotting caused by the remaining amounts of liquid.

There have been many attempts to improve dryer systems and drying methods so as to eliminate the need for edge exclusion by completely drying the wafer substrate. However, none have fully solved the problem in an effective and efficient manner.

For example, Mohindra, et al., U.S. Pat. No. 5,571,337, teaches pulsing a drying fluid such as nitrogen gas at the edge of the partially completed semiconductor to remove the liquid from the edge. Application of the Mohindra process results in evaporation of the liquid at the contact points. Evaporation is undesirable because particles or non-purities that may have been present in the water are left behind, both of which decrease yields. Moreover, the equipment necessary to perform the Mohindra process can be expensive and cumbersome.

McConnell, et al., U.S. Pat. No. 4,984,597, teaches using large amounts of IPA to replace water and enhance drying. However, such a process requires special tanks and elaborate support equipment to safely handle and process the IPA. Additionally, the McConnell process is costly due to the large amounts of IPA used.

A third drying system is taught by Munakata in U.S. Pat. No. 6,125,554. Munakata teaches a system for drying substrates comprising a rack having grooves for supporting substrates in a vertical position. The substrates are contacted and supported in the grooves of the rack. Each groove has an aperture near the groove that is capable of sucking water that adheres to the substrate near the groove contact point into the aperture. This system requires additional equipment to create a vacuum force at each groove and the open apertures and cavities within the rack can present problems in a liquid filled process tank because of air bubbles and trapped particles. Additionally, the rack used in Munakata can be both expensive and difficult to manufacture.

Many other systems and methods have been proposed to try to solve the edge exclusion problem resulting from the inability to efficiently remove water residue from the contact points between the edges of substrates and the supporting devices of dryers in a clean, low cost, and timely manner, but none have completely solved the problem.

Recently, methods and systems for processing a single substrate at a time have become widely used. An example of such a system is disclosed in U.S. Pat. No. 6,295,999, Bran. Such systems and methods support a single substrate in a horizontal orientation and rotate the substrate during processing. These single-substrate apparatus and processing methods suffer from the same problems discussed above with respect to edge exclusion and inadequate drying.

### SUMMARY OF THE INVENTION

It is therefore an objective of the present invention to provide a quicker method of drying high value objects, such as substrates.

A further objective of the present invention is to provide a more cost-effective method of drying high value objects.

A yet further objective of the present invention is to reduce or eliminate the problem of edge exclusion that exists at contact points between the support structure and the objects being dried.

A still further objective is to improve yields of high value integrated circuits from silicon wafers.

Yet another objective of the present invention is to reduce the need for great amounts of expensive drying chemicals.

Still another objective of the present invention is to provide and apparatus and method of drying a single substrate in accordance with the previous objects.

Additional objects and advantages of the invention will be set forth in the description that follows and will become apparent to those skilled in the art upon examination of the following or may be learned with the practice of the invention. The objects and advantages of the invention may be realized and obtained by means of the instrumentalities and combinations particularly pointed out in the claims.

In one aspect, the invention is an apparatus for drying at least one substrate comprising: a rotatable support comprising a fixture for supporting a substrate in a substantially horizontal orientation by contacting only a perimeter region of a substrate; the fixture comprising one or more contact surfaces that contact and support the perimeter region of the substrate; and wherein the one or more contact surfaces comprise a capillary material.

Preferably, the fixture is adapted to support the perimeter region of the substrate by contact with capillary material exclusively. Constructing the fixture so that all surfaces of contact between the perimeter region of the substrate and the fixture comprise the capillary material will help ensure that all liquid that becomes trapped between the substrate and the fixture will be drawn into the capillary material and away from the substrate, thereby improving drying and reducing edge exclusion.

In one embodiment, the fixture can be constructed entirely of capillary material. Alternatively, the fixture can comprise a channel of capillary material extending from the capillary material of the contact surfaces and through the fixture. This channel of capillary material allows liquid to be drawn outwardly away from the substrate. Rotation of the support causes centrifugal forces to pull the liquid that has been drawn into the channel outwardly through the channel.

While the capillary material can be any material that is capable of drawing in liquid through the use of capillary forces, it is preferred that the capillary material be a cellular capillary material, such as a porous flouropolymer or a porous polypropylene (“PP”).

In order to hold a substrate in place during rotation, the apparatus may comprise one or more clamps for securing the substrate to the fixture. In this embodiment, the one or more clamps will preferably have an engagement surface that contacts and secures the substrate in place during rotation. Most preferably, the engagement surfaces of the clamps will also comprise the capillary material.

In one embodiment, the fixture can comprise a flange extending from an inner surface of the fixture. In such an embodiment, the flange forms a step-like groove having a floor and a wall extending upward from the floor on an inner portion of the fixture. When a substrate is positioned on the fixture, the floor of the groove contacts a bottom surface of the perimeter region of the substrate and the vertical wall contacts an edge of the substrate. Thus, this embodiment, it is the floor and the wall of the groove that act as the contact surfaces and are formed of the capillary material.

If desired, at least one channel of the capillary material can be provided that extends from the capillary material of the wall and the floor of the groove and through the fixture. In this embodiment, the channel of the capillary material preferably terminates in an exposed surface on an outer surface of the fixture.

The fixture is preferably a generally ring-shaped fixture. The apparatus can further comprise a process chamber wherein the rotatable support is positioned in the process chamber. The apparatus can also comprise a source of a drying fluid positioned to apply a meniscus of the drying fluid to a substrate positioned on the rotatable support.

In another aspect, the invention can be an apparatus for drying at least one substrate comprising: a rotatable support comprising a fixture having a flange protruding from an inner surface, the flange forming a step-like groove in the fixture having a floor and a wall extending upward from the floor; wherein the step-like groove is sized and shaped to accommodate a substrate so that the floor of the groove contacts a bottom surface of a perimeter region of the substrate and the vertical wall contacts an edge of the substrate; and wherein all surfaces of the floor and wall that contact the perimeter region of the substrate when the substrate is supported by the fixture comprise a capillary material.

In yet another aspect, the invention can be an apparatus for drying at least one substrate comprising: a rotatable support comprising at least one fixture adapted to contact a perimeter region of a substrate and support the substrate in a substantially horizontal orientation; the perimeter region of the substrate contacting the fixture at one or more contact surfaces; and wherein the contact surfaces comprise a capillary material. In this embodiment, the fixture(s) adapted to contact and support the perimeter region of the substrate can be portions of a segmented ring or any other structure that can adequately support the substrate at its perimeter.

In still another aspect, the invention is a method of drying a substrate comprising: providing a rotatable support comprising a fixture for supporting a substrate in a substantially horizontal orientation by contacting only a perimeter region of a substrate; contacting a wet substrate on the rotatable support so that only the perimeter region of the substrate contacts the fixture, wherein all surfaces of the fixture that contact the substrate comprise a capillary material; rotating the fixture so as to remove a major portion of liquid from the substrate; and wherein remaining liquid from the substrate is drawn into the capillary material and away from the substrate.

In a further aspect, the invention can be a method of drying a substrate comprising: providing a process chamber having a rotatable support comprising a generally ring shaped fixture; supporting a wet substrate on the rotatable support so that a perimeter region of the substrate contacts the generally ring shaped fixture at one or more contact surfaces, the substrate being supported by the generally ring shaped fixture in a substantially horizontal orientation, the contact surfaces comprising a capillary material; rotating the rotatable support so as to remove a major portion of liquid from the substrate; and drawing remaining liquid from the substrate with the capillary material.

The methods can further comprise the step of applying a drying liquid to the substrate during the rotating step. The drying liquid can comprise isopropyl alcohol and the capillary material can be a porous flouropolymer or a porous PP. As with the apparatus, the inventive method is not limited to being practiced with a support having a ring shaped fixture but can be practiced with any fixture(s) adapted to contact the perimeter region of the substrate and support the substrate in a substantially horizontal orientation.

The inventive methods of the present application can be used in conjunction with a multitude of semiconductor processing steps, including etching, rinsing, and stripping. In many cases, all of these steps can be performed sequentially without moving the substrate from the apparatus of the invention.

### BRIEF DESCRIPTION OF THE DRAWINGS

FIG. 1 is a cross-sectional schematic of a single-wafer drying system according to an embodiment of the present invention and supporting a wafer.

FIG. 2 is a top view of the rotatable support of the single-wafer drying system of FIG. 1.

FIG. 3 is a top view of the rotatable support of the single-wafer drying system of FIG. 1 with a wafer supported thereon.

FIG. 4 is a close-up view of area III-III of FIG. 1 with the wafer removed and showing detail along a cross-section of the ring shaped fixture of the support.

FIG. 5 is a close-up view of area III-III of FIG. 1 showing detail along a cross-section of the ring shaped fixture of the support and supporting a wafer.

FIG. 6 is a close-up view of area III-III of FIG. 1 showing detail along a cross-section of the ring shaped fixture of the support and a clamp securing a wafer in position.

### MODES FOR CARRYING OUT THE INVENTION

The figures and following description describes embodiments of the present invention for purposes of illustration only. Those skilled in the art will readily recognize from the following discussion that alternative embodiments of the structures and methods illustrated herein may be employed without departing from the principles of the invention.

As the size of semiconductor wafers increases, rather than cleaning a cassette of wafers at once, it is more practical and less expensive to use a cleaning apparatus and method that cleans a single wafer at a time.

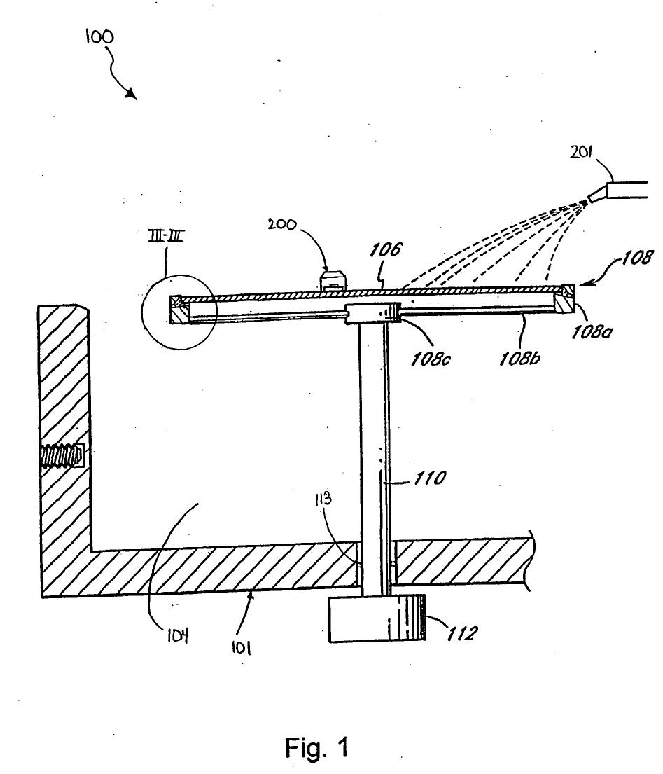

Referring to FIG. 1, a substrate drying system 100 is illustrated according to an embodiment of the invention. The drying system 100 comprises a rotatable support 108 for supporting a single semiconductor wafer 106 in a substantially horizontal orientation. The rotatable support 108 is positioned in a process chamber 104 which is defined by wall 101. A nozzle 201 is provided for applying processing fluids, such as cleaning fluids, stripping fluids, and/or drying fluids to the wafer 106 as needed.

The rotatable support 108 comprises a ring shaped fixture 108a, a plurality of spokes 108b, a hub 108c, and a shaft 110. The ring shaped fixture 108a is supported by a plurality of spokes 108b which are in turn connected to a hub 108c. The hub 108c is supported on the shaft 110. The shaft 110 extends through the bottom wall 101 of the processing chamber 104. An O-ring 113 or other seal can be added around the shaft 110 to hermetically seal the bottom wall 101 of the process chamber 104. Outside the process chamber 104, the shaft 110 is connected to a motor 112 so that the entire support 108 and the wafer 106 can be rotated as needed during processing. The mechanical/operable connection of the shaft 110 to the motor 112, and the operation of the motor 112 during wafer processing is well within the ambit of those skilled in the art.

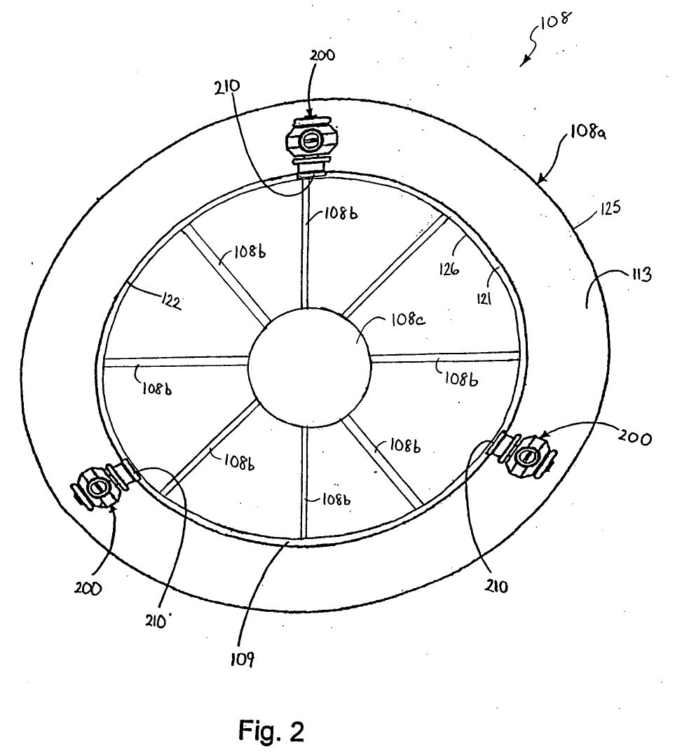

Referring now to FIG. 2, a top view of the rotatable support 108 is illustrated. As can be seen, the ring shaped fixture 108a is substantially circular in shape. The invention, however, is not so limited and the fixture can take on any shape desired, including without limitation oval, square, rectangular, or triangular. The exact shape will be dictated by the shape of the substrate to be supported thereby. Moreover, the fixture does not have to be a solid single structure but can be a plurality of truncated segments adapted to engage only small portions of the perimeter region of the substrate about its circumference at intermittent points, such as for example, a segmented ring fixture.

Three clamps 200 are provided on the top surface 113 of the ring shaped fixture 108a for engaging and securing a wafer 106 thereto during rotating and processing. The three clamps 200 are provided on the top surface 113 of the ring shaped fixture 108a approximately 120° apart from one another.

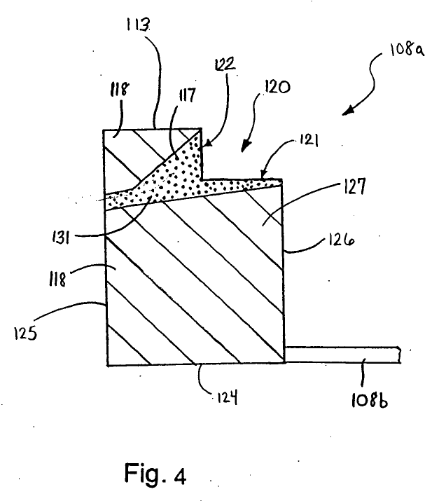

Referring now to FIG. 4, the ring shaped fixture 108a comprises a bottom surface 124, an outer surface 125, an inner surface 126, and a top surface 113. The outer surface 125 forms the outer circumference/periphery of the ring shaped fixture 108a while the inner surface 126 forms the inner circumference/periphery of the ring shaped fixture 108a. The inner surface 126 is formed by the wall of a flange portion 127 that protrudes inward from the main body of the ring shaped fixture 108a.

The flange 127 forms a step-like groove 120 on the top inner portion of the ring shaped fixture 108a. The step-like groove 120 extends about the entire inner circumference of the ring shaped fixture 108a. The step-like groove comprises a floor 121 and a vertical wall 122 that extends upward from the floor 121. The floor 121 of groove 120 forms a ledge upon which the perimeter region of the bottom surface of a substrate 106 rests. The vertical wall 122 acts as a restraint to prohibit substantial horizontal movement of the wafer 106 during rotation. The material of construction of the ring shaped fixture 108a, which is of the main concern of the present invention, will be discussed in greater detail below.

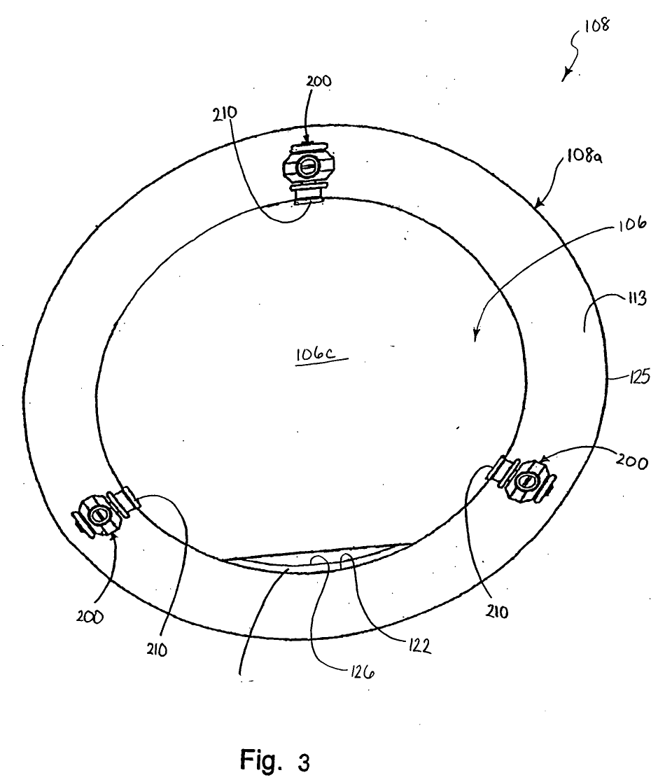

Referring now to FIG. 3, when a wafer 106 is loaded onto the rotatable support 108, the clamps 200 are positioned in an unobtrusive open position (not illustrated). The wafer 106 is then aligned above and lowered onto the ring shaped fixture 108a so that the perimeter region of the wafer 106 rests in the groove 120. As such, the bottom surface of the perimeter region of the wafer 106 rests atop the floor 121 of the groove 120 while the edge of the wafer 106 is in contact with the vertical wall 122 of the groove. The majority of wafer 106 is not in contact with any part of the support 108. The positioning of the wafer 106 on the ring shaped fixture 108a, and the contact therebetween, will be discussed in greater detail below.

Once the wafer 106 is in position on the ring shaped fixture 108a, the clamps 200 are moved into a closed position (illustrated), causing the grippers 210 of clamps 200 to be above the top surface 106c of the perimeter region of the wafer 106. The grippers 210 press down on top surface 106c of wafer 106 at three locations about the perimeter region of the wafer 106, thereby securing the wafer 106 in position for processing.

While clamps 200 are illustrated as being used to secure the wafer 106 in place, the invention is not so limited. For example, other means can be used, such as latches, a tight fit assembly, an upper ledge above the floor 121 forming a recess into which the wafer edge will slidably fit, or a suction assembly. In fact, it may not be necessary to use any means at all to hold the wafer 106 in place in some embodiments of the invention.

Referring back to FIG. 4, the ring shaped fixture 108a is constructed of a combination of capillary material 117 (illustrated as the spotted material) and non capillary material 118 (illustrated as the material with diagonal lines). As used herein, a “capillary material” is any material that is capable of drawing in liquid as a result of capillary forces that is either a closed cell material with pores/cavities or an open cell material with spaces/voids between its mass. A material can inherently be a capillary material or can be altered so as to be a capillary material, such as for example by making the material porous. The term “non-capillary material,” as used herein, means any material that does not exhibit a significant ability to draw liquid into it through capillary forces and is not an open cell material or a closed cell material.

Preferably, the capillary material is a cellular capillary material. Suitable examples of cellular capillary materials that can be used in practicing the present invention are porous flouropolymers, such as polytetraflouroethylene (“PTFE”) and PVDF. Porous PP is also a suitable cellular capillary material. When porous PP is used, acceptable pore size is in the range of 125 to 170 microns. Acceptable pore volume of the porous PP ranges between 35-50%. This means that 35-50% of the volume of the porous PP is open air. While porous PP and porous PTFE are the preferred cellular capillary materials to be used in the present invention, those skilled in the art will understand that the term capillary material encompasses a much broader range of materials, including materials not yet known or discovered, so long as these materials exhibit the ability to draw liquid in through the capillary force phenomenon. Examples of suitable non-capillary materials include non porous flouropolymers, such as PP, PTFE, and PVDF.

The floor 121 and the vertical wall 122 of the step-like groove 120 are constructed of cellular capillary material 117. The cellular capillary material 117 of the ring shaped fixture 108a forms a channel 131 that extends from the floor 121 and the wall 122 and through the non-capillary material 118 of the ring shaped fixture 108a. The channel 131 terminates at the outer surface 125 of the ring shaped fixture 108a in such a manner that the capillary material is exposed on the outer surface 125.

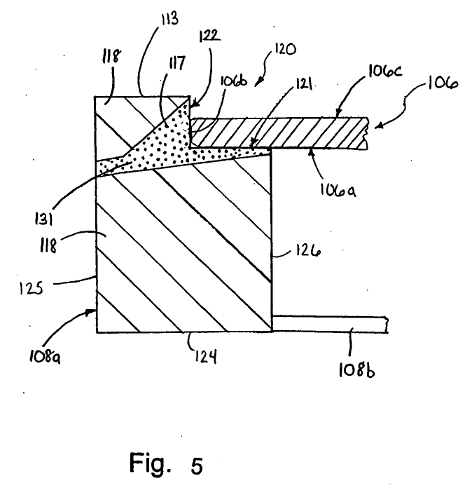

Referring now to FIG. 5, when a wafer 106 is placed on the ring shaped fixture 108a for processing, only the perimeter region of the bottom surface 106a of the wafer 106 rests on the floor 121 of the groove 120. The edge 106b of the wafer 106 contacts the wall 122. Because the floor 121 and the wall 122 are constructed of capillary material 117, when the wafer 106 is supported by the ring shaped fixture 108a, the wafer 106 is exclusively in contact with capillary material 117. As used herein, the surfaces of the support 108 that are in contact with the wafer 106 when the wafer 106 is supported thereby are referred to as contact surfaces.

By constructing the contact surfaces of the ring shaped fixture 108a, (i.e. the floor 121 and the wall 122 in this embodiment), of capillary material 117, liquids that get trapped between the wafer 106 and the contact surfaces will be drawn into the capillary material 117 and away from the wafer 106, thereby drying the wafer 106 completely and reducing and/or eliminating edge exclusion.

Providing the channel 131 of capillary material through the ring shaped fixture 108a allows the liquid that is drawn into the cellular capillary material 117 to be pulled outwardly by centrifugal forces through the channel 131 and away from wafer 106 during rotation of the support 108. This is advantageous because it performs a purging function in that particles and contaminants that become trapped in the capillary material 117 are moved away from the wafer 106. Moreover, the channel 131 allows the capillary material 117 to drain, thereby drying the capillary material so that it does not become saturated and unable to perform its capillary drying function and the contact surfaces.

In an alternative embodiment, the ring shaped fixture 108a can be constructed entirely of capillary material 117, so long as capillary material is selected that provides sufficient rigidity to support the wafer 106 during processing.

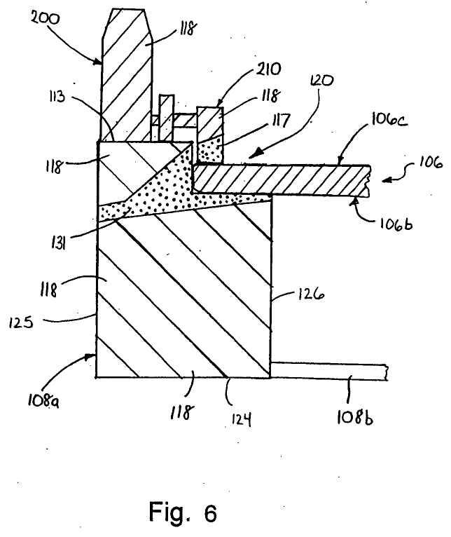

Referring now to FIG. 6, the bottom surface/portion of the gripper 210 of each clamp 200 may also be constructed so that the surface of the gripper 210 that contacts/engages the top surface 106c of the wafer 106 is constructed of the capillary material 117. When this is done, all of the contact surfaces of the support 108 (FIG. 1) are constructed of capillary material, thereby helping to eliminate the possibility of liquids getting trapped between the any surface of the perimeter region of the wafer 106 and the support 108.

A method of drying according to an embodiment of the present invention will now be described. First, a wafer 106 is positioned in the support 108 as illustrated in FIGS. 1-5 above after processing and/or rinsing. The wafer 106 may or may not have been supported in the support 108 during the processing and/or rinsing sequence. The wafer 106 is then rotated at a desired rotational speed, causing a centrifugal force to remove a majority of the liquid on the surface of the wafer 106 that remained from the processing sequence. Optionally, a drying fluid, such as isopropyl alcohol, may also be supplied to the surface of the wafer 106 via the nozzle 201 at this time. As discussed above, small amounts of liquid may get trapped about the perimeter region of the wafer 106 between the contact surfaces of the support 108 and the wafer 106. However, because all of the contact surfaces of the support 108 are constructed of capillary material 117, the remaining liquid will be drawn into the capillary material 117 and away from the wafer 106, thereby completely drying the wafer 106. Centrifugal forces acting on the capillary material 117 will force liquid that is drawn into the channel 131 further outward, through the channel 131, and out of the capillary material 117 that is exposed on the outer surface 125 of the fixture 108a. This helps to ensure that the capillary material will remain below saturation levels and capable of drawing in liquid as necessary.

The process chamber 104 can be sealed during the processing and/or drying sequences by closing a lid or otherwise shielding the process chamber 104 from the external environment.

While the invention has been described and illustrated in detail, various alternatives and modifications will become readily apparent to those skilled in the art without departing from the spirit and scope of the invention. Particularly, the apparatus and method of invention are not limited to removing DI water after a rinse step but can be used to remove any liquid from the substrate.

What is claimed is:

1. An apparatus for drying at least one substrate comprising:
a rotatable support comprising a fixture for supporting a substrate in a substantially horizontal orientation by contacting only a perimeter region of a substrate;
the fixture comprising one or more contact surfaces that contact and support the perimeter region of the substrate; and
wherein the one or more contact surfaces comprise a capillary material.

2. The apparatus of claim 1 further comprising one or more clamps for securing the substrate to the fixture, the one or more clamps having an engagement surface that contacts and secures the substrate to the fixture during rotation, wherein the engagement surface comprises a capillary material.

3. The apparatus of claim 1 wherein the fixture is a generally ring shaped fixture.

4. The apparatus of claim 1 wherein the contact surfaces of the fixture are formed entirely of the capillary material.

5. The apparatus of claim 4 wherein the fixture is constructed entirely of the capillary material.

6. The apparatus of claim 1 wherein for each contact surface, the fixture comprises a channel of capillary material extending from the capillary material of the contact area and through the fixture.

7. The apparatus of claim 1 wherein the fixture comprises a flange extending from an inner surface of the fixture, the flange forming a step-like groove having a floor and a wall extending upward from the floor, and wherein when a substrate is positioned on the fixture, the floor of the groove contacts a bottom surface of the perimeter region of the substrate and the vertical wall contacts an edge of the substrate, the floor and wall forming the contact surfaces comprising the capillary material.

8. The apparatus of claim 7 further comprising at least one channel of the capillary material extending from the capillary material of the contact surfaces of the groove and through the fixture.

9. The apparatus of claim 8 wherein the channel of the capillary material has an exposed surface on an outer portion of the fixture

10. The apparatus of claim 1 further comprising at least one channel of the capillary material extending from the capillary material of the contact surfaces and through the fixture.

11. The apparatus of claim 1 further:
wherein the fixture is a ring-shaped fixture comprising a flange extending from an inner surface of the ring shaped fixture, the flange forming a step-like groove having a floor and a wall extending upward from the floor;
wherein when a substrate is positioned on the fixture, the floor of the groove contacts a bottom surface of the perimeter region of the substrate and the vertical wall contacts an edge of the substrate, the floor and wall forming the contact surfaces comprising the capillary material; and
a channel formed of the capillary material extending from the capillary material of the contact surfaces, through the fixture, and to an outer surface of the ring-shaped fixture.

12. The apparatus of claim 1 further comprising a process chamber, the rotatable support positioned in the process chamber.

13. The apparatus of claim 12 further comprising a source of a drying fluid positioned to apply a meniscus of the drying fluid to a substrate positioned on the rotatable support.

14. The apparatus of claim 1 wherein the capillary material is cellular capillary material.

15. The apparatus of claim 14 wherein the cellular capillary material is a porous flouropolymer or PP.

16. An apparatus for drying at least one substrate comprising:
a rotatable support comprising a fixture having a flange protruding from an inner surface, the flange forming a step-like groove in the fixture having a floor and a wall extending upward from the floor;
wherein the step-like groove is sized and shaped to accommodate a substrate so that the floor of the groove contacts a bottom surface of a perimeter region of the substrate and the vertical wall contacts an edge of the substrate; and
wherein all surfaces of the floor and wall that contact the perimeter region of the substrate when the substrate is supported by the fixture comprise a capillary material.

17. The apparatus of claim 16 wherein the fixture is ring-shaped.

18. The apparatus of claim 16 wherein the fixture comprises a channel of the capillary material extending from the surfaces of the floor and wall that contact the perimeter region of the substrate to an outer surface of fixture, the channel extending through non-capillary material.

19. A method of drying a substrate comprising:
providing a rotatable support comprising a fixture for supporting a substrate in a substantially horizontal orientation by contacting only a perimeter region of a substrate;
supporting a wet substrate on the rotatable support so that only the perimeter region of the substrate contacts the fixture, wherein all contact surfaces of the fixture that contact the substrate comprise a capillary material;
rotating the fixture so as to remove a major portion of liquid from the substrate; and
wherein remaining liquid from the substrate is drawn into the capillary material and away from the substrate.

20. The method of claim 1 wherein the fixture comprises at least one channel of the capillary material extending from the capillary material of the contact surfaces and through the fixture, and wherein during rotation of the fixture, liquid in the channel is drawn away from the capillary material of the contact surfaces by centrifugal force.
